(19) United States
(12) Patent Application Publication
(10) Pub. No.: US 2016/0031088 A1
(43) Pub. Date: Feb. 4, 2016

(54) GANTRY TYPE WORKPIECE TRANSFER APPARATUS

(71) Applicant: Kondo Seisakusho Co., Ltd., Aichi (JP)

(72) Inventor: Yoshio Suzuki, Aichi (JP)

(21) Appl. No.: 14/577,622

(22) Filed: Dec. 19, 2014

(30) Foreign Application Priority Data
Oct. 21, 2013 (JP) 2013-217964

(51) Int. Cl. B25J 11/00; B25J 5/02; B23Q 7/04

(52) U.S. Cl. CPC B25J 11/00; B23Q 7/048; B25J 5/02

(57) ABSTRACT

The present invention provides a gantry type workpiece transfer apparatus provided with a spanning gantry rail that extends between a workpiece delivery unit/removal unit and a machine tool; a mobile part, movably attached to this gantry rail, that moves to positions corresponding to the delivery unit/removal unit and the machine tool; a first arm, extending downward along the vertical direction from this mobile part, with the lower end part thereof facing the front door of the machine tool when the mobile part has moved to a position corresponding to the machine tool; an articulated arm, attached to the lower end part of the first arm, configured so as to enter the interior of the machine tool and to retract to outside the machine tool from the front door of the machine tool; and a robot hand, attached to the articulated arm, that places/takes the workpiece on the worktable of the machine tool.

### CROSS REFERENCE TO RELATED APPLICATIONS

This application claims priority under 35 U.S.C. 119 based upon Japanese Patent Application Serial No. 2013-217964, filed on Oct. 21, 2013. The entire disclosure of the aforesaid application is incorporated herein by reference.

### FIELD OF THE INVENTION

The present invention pertains to a workpiece transfer apparatus that transfers a workpiece at above a machine tool and places/takes the workpiece, and specifically to a gantry type workpiece transfer apparatus.

### BACKGROUND OF THE INVENTION

In general, when supplying workpieces to and discharging them from a machine tool, a gantry type workpiece transfer apparatus, which is effective for saving space at the installation site, is often used. In particular, for a machine tool with a top cover that opens and closes, a vertical-drive workpiece transfer apparatus is often used because it is possible to transfer a workpiece in a short distance simply by the action of traveling left or right on a gantry rail and a vertical action.

However, in the case of a machine tool of the sort with a front cover not a top cover, that opens and closes, the abovementioned sort of configuration is not effective, so an apparatus which attaches an articulated robot at the upper part of the gantry rail is used, as disclosed in JP 8-174449 A, for example.

The configuration disclosed in JP 8-174449 A is one in which a wall-mount robot is fixed to a trolley that travels on a gantry rail. Like a floor-installed articulated robot, in this wall-mount robot a robot base and a first arm are linked by a first joint, the first arm and a second arm are linked by a second joint, the second arm and a third arm are linked by a third joint, and a robot hand is fixed to the third arm. The robot base and the arms are linked by joints, so individually swinging the joints causes vertical and forward/backward movement, and makes it possible to deliver and remove a workpiece. Also, the robot base and each arm may have their respective mechanisms for rotating in the axial direction, enabling more complicated actions.

However, an articulated robot with this configuration performs vertical and forward/backward movement by swinging the joints, so there is a problem in that when the robot hand is at a position near the robot base the first arm and the second arm are folded together, and the second joint, which is the part connecting the first arm and the second arm, juts out beyond the robot base to a position protruding into the walkway, making it necessary to establish the position of the safety cover that is provided for safety far into the walkway, and widening the space where the safety cover is installed.

Also, the wall-mount robot is attached to the trolley that travels on the gantry rail, so the entire weight of the wall-mount robot is applied to the trolley, so the trolley that supports that weight and the travel guide part become large. In addition, the output of the travel motor that is the drive source for driving the trolley to travel on the gantry rail becomes large, so the size of the entire apparatus becomes large, and the cost also becomes high.

### SUMMARY OF THE INVENTION

The present invention pertains to a gantry type workpiece transfer apparatus, and solves the problem of preventing the installation space between a machine and a safety cover, which is regulated by the action of robot, from becoming too large. It also solves the problem of making the overall size of a workpiece transfer robot be small by lightening the weight of an articulated robot.

As a means for solving the abovementioned problems, a gantry type workpiece transfer apparatus is provided to move a workpiece between a machine tool and a workpiece delivery unit/removal unit provided outside this machine tool, and to place/take the workpiece inside the machine tool. The aforementioned workpiece transfer apparatus is provided with a spanning gantry rail that extends between the workpiece delivery unit/removal unit and the machine tool; a mobile part, movably attached to this gantry rail, that moves to positions corresponding to the aforementioned delivery unit/removal unit and the machine tool; a first arm, extending downward along the vertical direction from this mobile part, with the lower end part thereof facing the front door of the abovementioned machine tool when the aforementioned mobile part has moved to a position corresponding to the abovementioned machine tool; an articulated arm, attached to the lower end part of the aforementioned first arm, configured so as to enter the interior of the machine tool and to retract to outside the machine tool from the front door of the aforementioned machine tool; and a robot hand, attached to the aforementioned articulated arm, that places/takes the abovementioned workpiece on the worktable of the machine tool.

The aforementioned first arm may also be configured to be capable of sliding vertically along the vertical direction.

Further, the aforementioned articulated arm may also be provided with a second arm linked to the first arm via a first joint that is capable of rotating around an axis parallel to the aforementioned gantry rail, and with a third arm linked to the second arm via a second joint that is capable of rotating around an axis parallel to the aforementioned gantry rail and that is provided with the aforementioned robot hand on the opposite end from the aforementioned second joint.

In addition, the aforementioned robot hand may have a plurality of hands, and the aforementioned third arm may be configured to be able to rotate around the longitudinal axis of the aforementioned arm, and the hand handling the workpiece can be selectively used by rotation of the aforementioned third arm.

The aforementioned first arm and/or the second arm may be configured to be able to rotate around the longitudinal axis of each arm.

As a result of the configurations described above, the joint at the linking part between the first arm and the second arm forms an acute angle and does not jut out into the walkway at the side opposite the machine, as is the case with other articulated robots, so the area that must be enclosed by a safety fence can be made small, and it becomes possible to effectively utilize the location.

In addition, in a conventional articulated robot in which the robot base and the first arm are connected by a joint, the robot base and the first arm and the first joint must bear the weight of the tip side from the second arm onward, so strength and weight become large, and the weight too becomes heavy in conjunction therewith.

However, according to the present invention, the robot base and the first arm slide vertically using a slide mechanism, not a swinging motion due to a first joint, so it is not necessary for the robot base and the first arm to have enough strength to enable that swinging motion, and it is possible to make the robot base and the first arm be small, so in conjunction therewith the weight of the robot itself can be greatly lightened. In our trial calculation, when an ordinary articulated robot is used the weight is 320 kg, compared to 210 kg for a robot in which the first arm is a sliding mechanism; the robot weight was reduced about 34%.

Also, lightening the robot weight can also reduce the load applied to the trolley that travels on the gantry rail, so it is possible to reduce the size of the travel motor that drives the trolley, and it is also possible to reduce the size and cost of the workpiece transfer robot.

In addition, providing a mechanism for rotating the third arm with respect to the axial direction of the third arm makes it possible to provide a plurality of robot hands at the end of the third arm, and to extract a processed workpiece and insert an unprocessed workpiece in a single series of actions—raising, rotating the third arm, lowering—in a short time.

Also, attaching a rotation mechanism to either the first arm or the second arm or to both enables even more complicated actions and makes it possible to transfer workpieces while avoiding jutting out inside the machine tool or at peripheral equipment.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1: An explanatory diagram showing the standby state of the workpiece transfer robot.

FIG. 2: An explanatory diagram showing the workpiece placing/taking state of the workpiece transfer robot.

FIG. 3: An explanatory diagram showing the state of the workpiece transfer robot and the machine.

FIG. 4: An explanatory diagram showing the standby state of a conventional workpiece transfer robot.

FIG. 5: An explanatory diagram showing the workpiece placing/taking state of a conventional workpiece transfer robot.

### DETAILED DESCRIPTION OF THE INVENTION

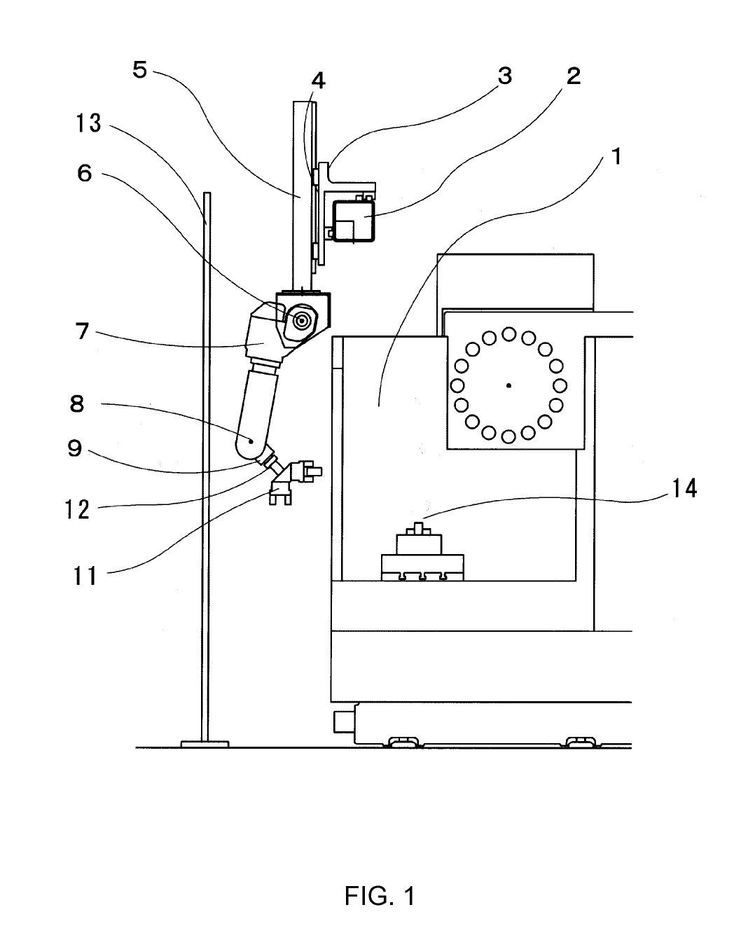

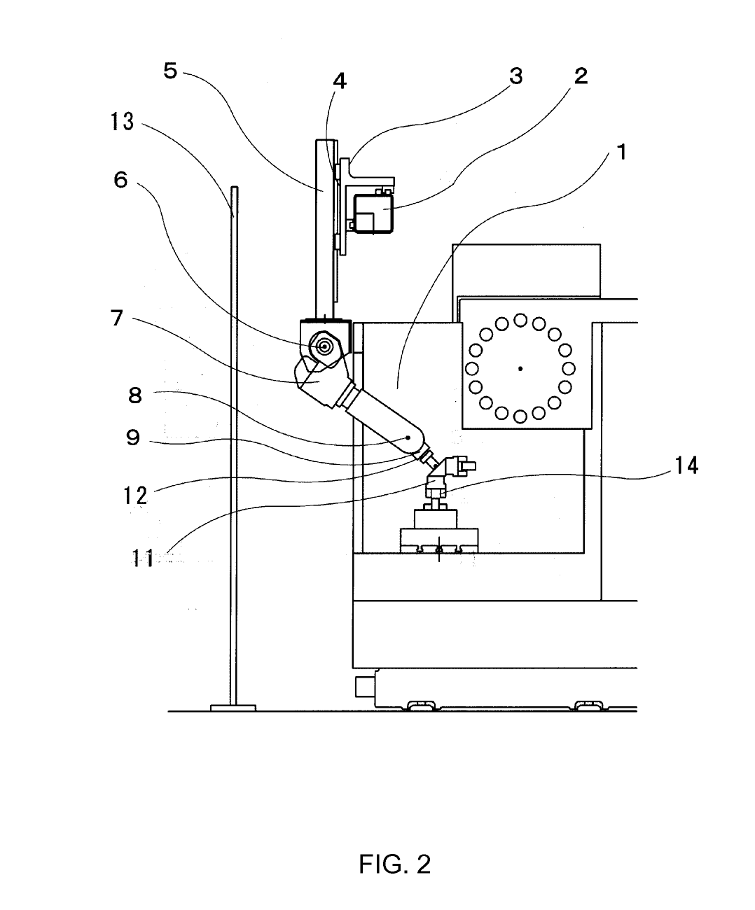

As shown in FIGS. 1-3, the workpiece transfer apparatus of the present invention is a gantry type workpiece transfer apparatus which transfers and delivers a workpiece to a machine tool 1.

### Embodiment 1

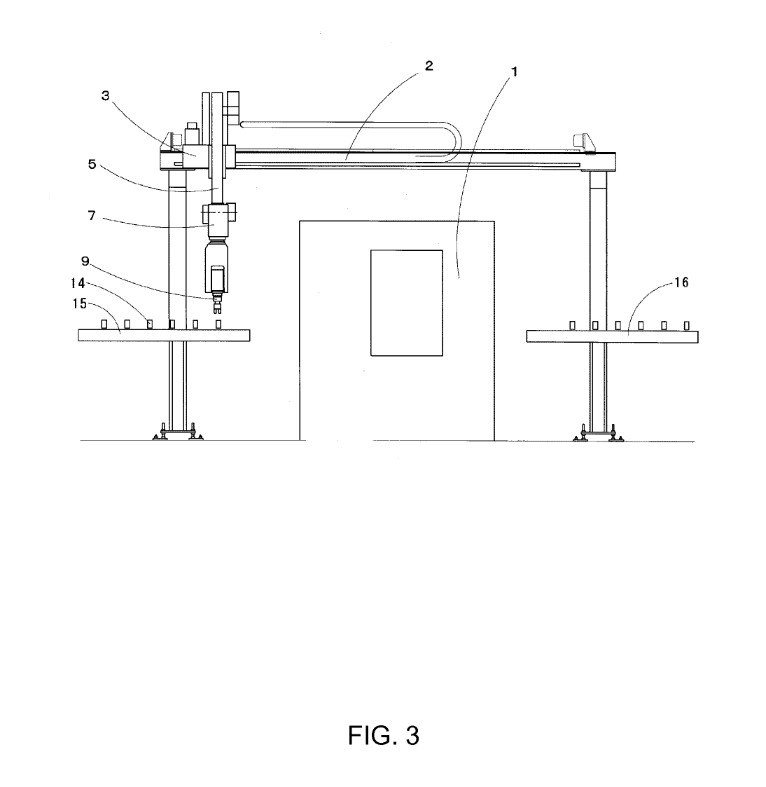

This workpiece transfer apparatus has a gantry rail 2 at the upper part of a portal frame; a trolley 3 is provided so as to be able to move left and right on the gantry rail 2. Using a robot fixed to the trolley 3, a workpiece 14 is transferred to the machine tool 1, and a workpiece that has been processed is transferred to the next step. FIG. 3 is an example in which a workpiece 14 that has been transferred by a delivery apparatus 15 is transferred to the machine tool 1 and a workpiece that has been processed is transferred to a discharge apparatus 16, but it is also possible to link a plurality of machines using one or a plurality of robots and perform transfer therebetween.

The robot has a robot base 4 fixed to the trolley 3; driving is performed so that the robot base 4 and a first arm 5 slide vertically. The first arm 5 is linked to a second arm 7 by a first joint 6, and swings centered on the first joint 6. The second arm 7 is linked to a third arm 9 by a second joint 8, and swings centered on the second joint 8.

A plurality of robot hands 11 are fixed to the third arm 9. The third arm 9 is configured with a third arm rotation mechanism 12 that rotates the third arm centered on the axial direction thereof, and it is possible to switch the direction of the robot hands 11. In this embodiment is there are a plurality of robot hands 11, and the third arm 9 has a third arm rotation mechanism 12, but other embodiments may be a single robot hand, or eliminate the third arm rotation mechanism 12.

Next, the operation shall be explained.

The trolley 3 is slid left or right to above the delivery apparatus 15.

The first arm 5 is lowered and clamps an unprocessed workpiece 14 from the delivery apparatus 15 using the robot hand 11, and the first arm 5 is raised. Next, the trolley 3 is slid and moved to in front of the machine tool 1, the first joint 6 is rotated, the second arm is moved, the first arm 5 is lowered, and the robot hand 11 is moved to above a processed workpiece inside the machine tool 1. Then the robot hand 11 is lowered to a position where it can clamp the processed workpiece, and the processed workpiece is clamped. Subsequently, the first arm 5 is temporarily raised and then the third arm rotation mechanism 12 is rotated, and the unprocessed workpiece that has been transferred from the delivery apparatus 15 is lowered to the position of the chuck of the machine tool 1, and the workpiece is delivered. Next, the first arm 5 is raised, the first joint 6 is swung, the processed workpiece is moved to outside the machine tool 1, the trolley 3 is moved to above the discharge apparatus (16), and the workpiece 14 is discharged, thereby completing the series of actions.

When doing so, the angles of the first joint and the second joint work harmoniously in order to perform transfer while keeping the orientation of the workpiece at a constant angle. Also, the distance the first arm 5 moves vertically is limited to a position where that the robot hand 11 and the second arm 7, etc. do not interfere with the machine tool 1, etc.

As a result of the abovementioned configuration and operation, the present invention has the following advantageous effects compared to prior art.

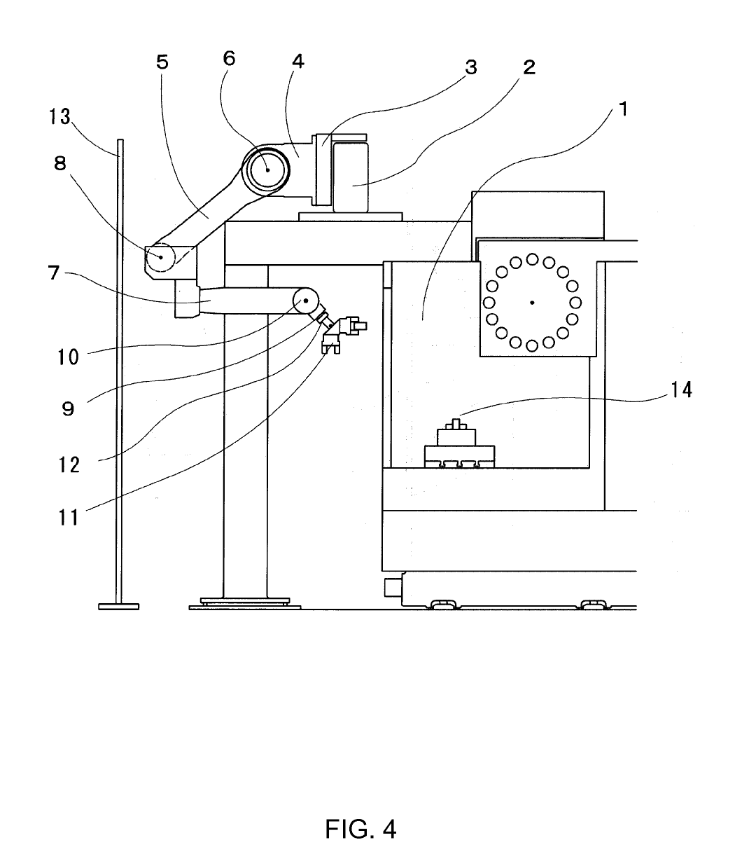

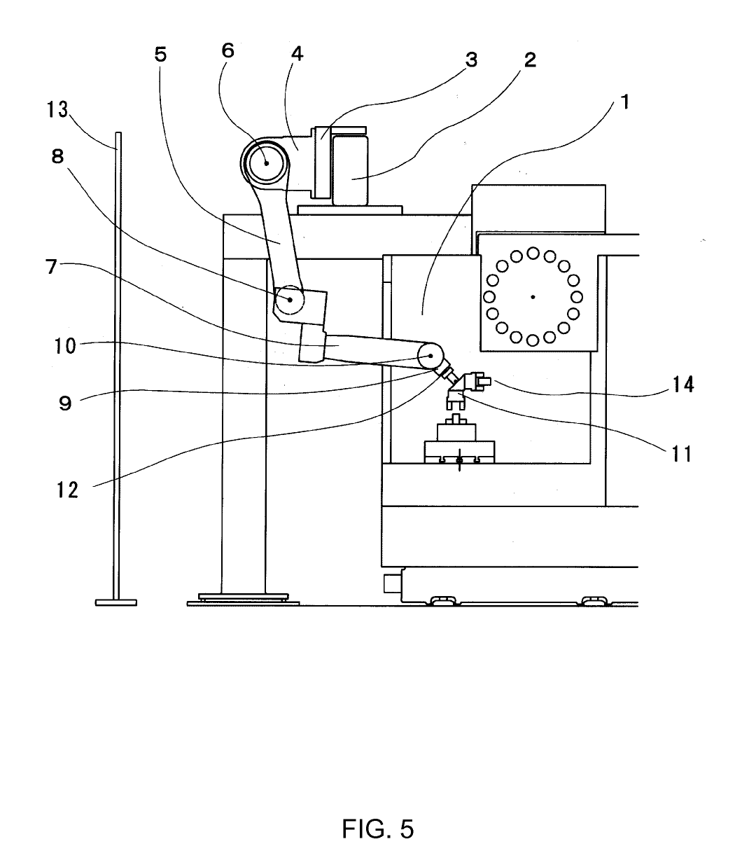

FIGS. 4-5 show the schematic configuration of a workpiece transfer apparatus that has a conventional articulated arm, such as the one in the invention disclosed in JP 8-174449 A in the Background of the Invention section. In these drawings, for ease of comparison with the present invention, the same codes have been assigned to constituent elements that can correspond to the constituent elements of the present invention, but this should not be interpreted as having any other significance.

In a robot of the type in which the robot base 4 and the first arm 5 are linked by the first joint 6 and the first arm 5 and the second arm 7 are linked by the second joint 8 as in the conventional robot shown in FIGS. 4-5, when the robot hand 11 is moved to outside the machine tool 1 the second joint 8 juts outward much farther than the robot base 4. This sort of situation necessitates a wide walkway in the robot action range, and it is necessary to put the installation location for a safety fence 13, etc. at a farther distance from the machine tool 1. Therefore, the installation space in the factory must be large. However, with the present invention this sort of outward jutting does not occur, so it is possible to shorten the distance from the machine tool 1 to the safety fence 13, and the installation space in the factory may be small.

Also, with the conventional robot shown in FIGS. 4-5 the first arm 5 and the second arm 7 operate by swinging of the first joint 6 and the second joint 8, so the positions of their respective centers of gravity fluctuate, and the guide part for the robot base 4 and the first arm 5 and the drive apparatus become large in order to bear their loads, and must be heavy. However, with the present invention there is little fluctuation in the center of gravity, so the guide part and the drive apparatus may be small or light compared to prior art. In particular, the robot base can be a component shared by both the base part of the first arm 5 and the trolley 3, so a great reduction in weight is possible.

This embodiment did not explain a configuration in which rotation mechanisms are attached to the first arm and the second arm, but if the abovementioned rotation mechanism is added, sometimes when the robot hand 11 enters the machine tool 1 there are cases when the hand cannot enter the machine tool 1 vertically because of the shape of the interior of the machine tool 1 or its cover, etc. In such cases, if rotation mechanisms are added to the first arm 5 and the second arm 7, it becomes possible to enter from a position without such interference.

The arrangements described above should be understood as being only two or three examples among a number of specific arrangements that illustrate applications of the basic principle of the present invention. A person of ordinary skill in the art could easily conceive of many other configurations without departing from the spirit and scope of the present invention.

The invention of the present application pertains to transferring workpieces to a machine tool, but can also be used as an apparatus for transfer to assembly machines or other machines. Also, instead of a robot hand it is possible to attach a variety of other tools, such as a welding gun, for application to other machine tools.

What is claimed is:

1. A gantry type workpiece transfer apparatus that moves a workpiece between a machine tool and a workpiece delivery unit/removal unit provided outside that machine tool and places/takes the workpiece in the machine tool, comprising:
a spanning gantry rail that extends between the workpiece delivery unit/removal unit and the machine tool,
a mobile part, movably attached to the gantry rail, that moves to positions corresponding to said delivery unit/removal unit and the machine tool,
a first arm, extending downward along the vertical direction from the mobile part, with the lower end part thereof facing the front door of said machine tool when said mobile part has moved to a position corresponding to said machine tool,
an articulated arm, attached to the lower end part of said first arm, configured so as to enter the interior of the machine tool and to retract to outside the machine tool from the front door of said machine tool, and
a robot hand, attached to said articulated arm, that places/takes said workpiece on the worktable of the machine tool.

2. The workpiece transfer apparatus of claim 1, wherein said first arm is configured to be capable of sliding vertically along the vertical direction.

3. The workpiece transfer apparatus of claim 2, wherein said articulated arm further comprises:
a second arm linked to the first arm via a first joint that is capable of rotating around an axis parallel to said gantry rail, and
a third arm linked to the second arm via a second joint that is capable of rotating around an axis parallel to said gantry rail and that is provided with said robot hand on the opposite end from said second joint.

4. The workpiece transfer apparatus of claim 3, wherein said robot hand further comprises a plurality of hands,
said third arm is configured to be able to rotate around the longitudinal axis of said arm, and
the hand handling the workpiece can be selectively used by rotation of said third arm.

5. The workpiece transfer apparatus of claim 4, wherein said first arm and/or second arm is configured to be able to rotate around the longitudinal axis of that arm.
